(19) United States
(12) Patent Application Publication
(10) Pub. No.: US 2007/0274291 A1
(43) Pub. Date: Nov. 29, 2007

(54) Method and Apparatus for Unified Management of Different Type of Communications Over Lan, Wan and Internet Networks, Using A Web Browser

(75) Inventor: Giuseppe Diomelli, Lari (IT)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: C.D.C. S.R.L., Fornacette di Calcinaia (IT)

(21) Appl. No.: 10/596,210

(22) PCT Filed: Mar. 16, 2004
(86) PCT No.: PCT/IB04/00769

§ 371 Date: Mar. 16, 2007

(30) Foreign Application Priority Data
Dec. 5, 2003 (IT) PI2003A000101

(51) Int. Cl. H04L 12/56

(52) U.S. Cl. 370/352

(57) ABSTRACT

A method, and apparatus, for the unified management of all types of communications, such as: telephone calls, faxes, SMS and MMS, video, e-mails, CHAT and multimedia communications in general, allows to interface various communications/telecommunications networks and their related transmission protocols. All outbound and inbound communications are controlled and globally managed through an Internet Web Browser that also generates a historical log of the communications and their contents using a single database. All the functions required for the fully integrated management of all the said types of communications to and from every device connected to the LAN comprising the apparatus, and/or the WAN, and/or the Internet, are generated by applying the invention method, thereby producing a full Computer Telephony Integration (CTI). Thanks to the method in question, the management of all types of communications is achieved without the need for any telephone switchboard (PBX, PABX, IPPBX).

### FIELD OF THE INVENTION

This invention refers to a method and apparatus for the unified management of telecommunications and multimedia communications over computer networks that provide, in particular, integrated support for telephone, video, multimedia communications and data transmission.

### DESCRIPTION OF THE PRIOR ART

Italian patent no. IT1316580 of the same applicant, discloses an apparatus, and a corresponding method, designed to support telephonic communications and data transmission through a single local computer network.

A further Italian patent, no. IT1316585, of the same applicant, discloses a specific device designed to connect telephone devices and peripheral computers to the aforementioned local computer network, so as to allow the operation of said telephone devices, regardless of whether they are associated with peripheral equipment (clients) or independent, stand alone devices, such as, for instance, fax machines or other commonly used telephone devices.

A subsequent Italian patent application, no. P12002A000026, in the name of the same applicant, describes a method for the management of phone communications, and related equipments, on local area computer networks which support data transmission and phone communications in an integrated way.

Whenever we make a call or send a FAX, an SMS, etc., we in fact use various means of communication that imply the existence of a range of communications STANDARDS and that therefore characterise TYPES of COMMUNICATIONS. These are then routed to various COMMUNICATIONS DEVICES or TERMINALS that allow the communication to go through.

In order to provide a better idea of the above, it would be useful to point out that:

COMMUNICATIONS STANDARDS are specific techniques involving communications protocols such as Q.931, H.320, T.38, V.17, H.323, SIP, MEGACO, etc., that ensure the functioning of the various types of communications networks such as ISDN, PSTN, LAN, INTERNET, etc; and

TYPES OF COMMUNICATIONS include all forms of communications, such as TELEPHONE CALLS, FAXES, SMS/MMS, VIDEOCALLS, E-MAILS, CHATS, etc.

Specific Italian or English acronyms and technical terms used in this document, are explained in the chapters entitled ACRONYMS and GLOSSARY at the end of the descriptive portion of this patent.

Any type of communication, therefore, uses various communications protocols and/or networks to reach the COMMUNICATIONS DEVICE or TERMINAL to which the communication is addressed, such as, for instance, a TELEPHONE HANDSET for a telephone call, a FAX machine or FAX SERVER for messages sent by facsimile transmission, a PERSONAL COMPUTER or the E-MAIL SERVER for e-mail messages, a CELL PHONE or a SERVER for SMS-MMS messages, a MONITOR or TELEVISION SCREEN for video calls or video conference calls, a PERSONAL COMPUTER for chats and interactive multimedia communications, etc.

In the face of increased market competition, technological advances have contributed to the mushrooming of available data that, apart from featuring a whole range of types, reach their destinations at different times, through a variety of communications networks, and above all, over very different Devices and/or Terminals. Regardless of the various types of communications that a user may send or receive, therefore, there is a need for greater streamlining and proper management of the user's overall communications needs.

A large number of attempts have been made so far throughout the world to find ways to optimise the management of overall communications, and each solution that has emerged, has left its mark on sectors such as CTI (Computer Telephony Integration), UM (Unified Messaging), VOIP (Voice over IP) or MOIP (Multimedia Over IP), as well as in the use the Internet for outbound and inbound telephone calls and in the field of multimedia communications in general.

Without going into the individual merits of these solutions, one need only observe that they cannot be easily integrated, insofar as the diversity of the software produced by diverse range of manufacturers, the variety of operating systems installed on network-connected devices and the large number of devices that require specific interfacing, generate so much complexity that it is very difficult, if not impossible, to offer a “full and unified management solution for all communications needs” designed for individual and corporate users.

Many solutions already available on the market today, provide optimal management only for a part of the user's communications needs, and especially when it comes to telecommunications and multimedia communications; these solutions are based on the use of various devices, such as voice recorders connected to a conventional or advanced telephone switchboard (PBX, PABX, IPPBX) or special devices fitted with hardware and software interfaces that allow for connections to the telephone switchboard that has so far proved almost universally indispensable for managing in- and out-bound calls.

Other solutions involve the use of custom-designed devices and/or software developed by various manufacturers that, however, more often than not, results in incomplete interoperability or precludes reliance on an Internet Web Browser as the main technology providing the user full management of his overall communications and interfacing with the Systems Administrator in charge of assign user privileges and rights.

Still other solutions in the field of CTI currently available on the market make it necessary for all the Client PCs connected to the LAN to use a single, specific operating system (generally Microsoft) that does not offer the same CTI functions to all the Devices (PCs, PDAs, etc) connected to the same LAN, but incorporating an Operating System other the popular Microsoft Windows, such as, OS, Apple, Linux, etc.

Lastly, there are solutions that entail the use of hybrid networks (for instance ETHERNET+ATM) to ensure the quality of communications services and therefore impose the use of very costly additional devices dedicated to providing the CTI and the telephony/videophony transmission function. In any event, these solutions do not allow an Internet Web Browser to be used for the complete management of all communications needs over a single LAN or WAN that is also connected to the Internet.

In other words, to date, it is possible to use CTI, UM VOIP/MOIP to manage various types or communications, and it is also possible to use a Web Browser for the purpose, but it is not possible to integrate all these technologies together in a simple manner, since communications in today's world pass through a very wide variety of different devices, such as hardware and software interfaces, PBX/PABX/IPPBX, voice recorders but also different software that rely on various databases hosted on diverse servers or devices. A Web Browser, if it is used at all, is merely assigned the task of enabling, through a dedicated server, certain standard telephone switchboard functions (PBX/PABX/IPPBX) or a central server capable of providing the necessary functions through Communications Devices and/or Terminals bearing a variety of brand names, that are not interchangeable and that have been specifically designed for the purpose or equipped with specific software that allows for the display and/or management only of certain basic commands and functions, such as making and receiving telephone calls, consulting messages left on the answering machine, accessing e-mail messages, etc.

### SUMMARY OF THE INVENTION

The main object of this invention is to propose a method, and apparatus, that allows for the control and management of all types of communications between Communications Devices and/or Terminals connected to a local area network (LAN), comprising said apparatus, apt to ensure integrated support for all communications and data transmission, regardless of the types of Communications Devices and/or Terminals used.

A further object of the invention is to propose a method and apparatus that provide for data transmission and allow to initiate, receive, control and manage, in a unified manner, all the communications from and between Communications Devices and/or Terminals connected to a LAN, or group of LANs, linked to said apparatus through public and private communications and telecommunications networks.

Another object of the invention is to propose a method and apparatus that allow to initiate, receive, control and manage in a unified manner, all communications even from Communications Devices and/or Terminals, including stand alone devices, connected to other LANs, situated in remote locations, that are however linked, via the Internet or otherwise, to the LAN to which said apparatus, including a single processor, a single software programme and a single Database, is connected. A further object of the invention is to propose a method and apparatus that allow to initiate, receive, control and manage all the communications between Communications Devices and/or Terminals connected to a LAN to which the apparatus of the invention is connected, providing also for the greatest possible flexibility in terms of the installation and connection of the said equipments, regardless of the hardware and software architecture of the Communications Devices and/or Terminals that are currently widely used.

Another object of the invention is to propose a method and apparatus that allow each Communications Device or Terminal connected to a LAN to which said apparatus is connected, to initiate, receive, control and manage, at the same time, one or more alternative inbound or outbound calls towards Communications Devices or Terminals located at various remote sites and connected to each other through digital networks, including the INTERNET, as well as through public and private communications networks such as PSTN, GSM, SATELLITE NETWORKS, etc., thereby allowing each Communications Device or Terminal fitted or associated with a display panel to initiate, receive and manage more than one call at a time.

These and other objects are achieved through a method and apparatus that allow for the innovative and complete management of all types of communications and telecommunications over computer networks that, in particular, can support telephone calls, video calls, multimedia communications and data transmission in an integrated manner, as indicated in the attached claims.

The invention completely overcomes all the problems described above, since no use at all is made of any conventional telephone switchboard PBX/PABX/IPPBX, insofar as all the functions for initiating, controlling and managing all types of telecommunications and multimedia communications in general, are managed through an Internet Web Browser using a single software programme that accesses a single Database hosted on a single Network Server, to provide therefore, full-fledged integration between CTI, UM, VOIP/MOIP, with the result that all the operations carried out by systems administrators, installation technicians and users of the invention method and apparatus, are substantially simplified.

The invention in fact eliminates the use of all the aforementioned devices and software currently required to integrate the various CTI and UM functions, and enables communications between different communications networks (PSTN, ISDN, LAN, INTERNET, etc.) and protocols (H.320, T.38, H.323, SIP, MEGACO, etc.) by relying on a single software programme that, once installed on a server, enables and manages within that server, all types of communications, such as TELEPHONE CALLS, FACSIMILE TRANSMISSIONS, SMS/MMS, VIDEO CALLS, E-MAILS, CHATS, etc. using an Internet Web Browser equipped with a toolbar through which overall communications can be initiated, received, controlled and completely managed. The invention allows for interaction with COMMUNICATIONS DEVICES and/or TERMINALS that are connected to the same LAN, and, via the Internet, even to other remote LANS, as well as directly to fixed and mobile telecommunications networks.

All the historical data of the communications are logged in a single database that, apart from providing for all possible statistical interactions for grouping even various types of communications, allows authorised users to access the database with a single click of a mouse, using the Internet Web Browser. As a result, all outbound and inbound communications, such as facsimile transmissions, SMS, recorded messages including multimedia messages, phone calls, etc., can be accessed and consulted in a simple manner, insofar as all the related data is stored in a single Database. It must be pointed out that this is not easily achieved using currently available technology, and in most cases it is impossible since, as noted earlier, nearly all currently available solutions use different devices and software that do not lend themselves to perfect integration.

In particular, the apparatus of the invention comprises a single central processor or Network Server and a single LAN infrastructure for the local transfer of all communications. Furthermore, the initiation, receipt, control and management of all types of communications can be carried out even from remote Communications Devices and/or Terminals, associated with other remote LANS or individually connected to digital networks, including in the Internet, and linked in any event, through digital networks to the LAN to which the central processor or Network Server, are connected. As a result, the Network Server allows these remote Communications Devices and/or Terminals to interact amongst themselves as well as with the Communications Devices and/or Terminals connected to said LAN.

The above apparatus includes a single software programme equipped with a single software nucleus (KERNEL) through which the COMMUNICATIONS CHANNELS of all types of communications are enabled, controlled and managed using interactive displays (WEB SERVICES).

The apparatus of the invention includes:
Logical-functional sections designed to support and manage all types of communications;
At least one section that stores the parameters associated with connected Communications Devices and/or Terminals as well as the historical data of managed communications, in a single database.

The logical-functional sections include, in particular:
Sections dedicated to the interfacing of said apparatus with the Communications Devices and/or Terminals connected to the LAN, as well as with fixed and mobile telephone networks and with digital networks, including the Internet;
Sections dedicated to the support of communications between Communications Devices and/or Terminals connected to the LAN and between Communications Devices and/or Terminals connected to telephone networks and other computer networks to which other Communications Devices and/or Terminals may be also connected;
Sections dedicated to the storage of historical data pertaining to the communications managed using the apparatus of the invention;
Sections dedicated to displaying specific interactive graphic interfaces on the visual display panels of the Communications Devices and/or Networks connected to computer networks, as well as to managing said graphic interfaces so as to allow the standard web browser methodology to be used to access and enable the operating functions of said apparatus.

The section dedicated to supporting communications between the Communications Devices and/or Terminals connected to the LAN and between said Communications Devices and/or Terminals and outside telephone and computer networks, operates by accessing the parameters and settings associated with these Communications Devices and/or Terminals and stored in the storage section, said parameters and settings being apt, in particular, to identify the Communications Devices and/or Terminals as well as their related communications protocols.

The standard Internet browser programme that displays specific interactive graphic interfaces, is enabled:
whenever the central processor or Network Server receives one or more communications (telephone calls, multimedia communications, etc.) addressed to any of the Communications Devices and/or Terminals connected to the LAN or other LANs, even via the Internet;
whenever the telephone handset is picked up, or an equivalent operation is undertaken on any one of the Communications Devices and/or Terminals, including telephones, connected to the LAN or other LANs, even via the Internet;
upon interaction with the Communications Devices and/or Terminals connected to the local LAN and other LANs and/or the Internet, so as to enable, collect, transfer, terminate, control and manage in any other mode, all the user's communications, on an individual, multiple or mixed basis.

After data have been stored into the specific sector of the Database, the invention method allows for the searching and the automatic selecting of the cheapest type of transmission network for each communication, and then routing the communication over that network.

From the above, the advantages connected with the proposed method and apparatus are immediately clear, for the unified management of all types of communications between Communications Devices and/or Terminals connected to a LAN or to telephone and computer networks that are connected to the said LAN. The invention method and apparatus also provides for full monitoring of the communication underway and further stores historical/management data pertaining to the communication. Individual users can access the functions made available by the invention through immediate interaction, thanks to the standard Internet Browser procedure used for the exchange of data and commands through the various computer networks to which the Communications Devices and/or Terminals are connected.

### BRIEF DESCRIPTION OF THE DRAWINGS

In order to better understand the features and advantages of the invention and the substantial difference in respect of currently available systems, reference will be made to a non-limitative embodiment of the invention, with the help of the attached drawings, in which:

FIG. 1 represents a schematic block diagram of an apparatus according to the invention connected to a LAN, to other LANs, including the Internet, as well as to outside fixed and mobile telecommunications networks;

FIG. 2 represents examples of interactive graphic interfaces used to manage communications through the apparatus of the invention;

FIG. 3 shows details of further examples of graphic interfaces pertaining to the Internet Web Browser, in the form of several toolbars;

FIG. 4 represents a block diagram of two apparatus according to the invention connected to two LANs, both connected to the Internet as well as to other public and private communications networks;

FIGS. 5 and 6 represent flowcharts showing the management of alternative calls managed at the same time as calls already underway, from Communications Devices or Terminals connected to LANs that may or may not belong to the same group or corporation.

### DESCRIPTION OF PREFERRED EMBODIMENTS

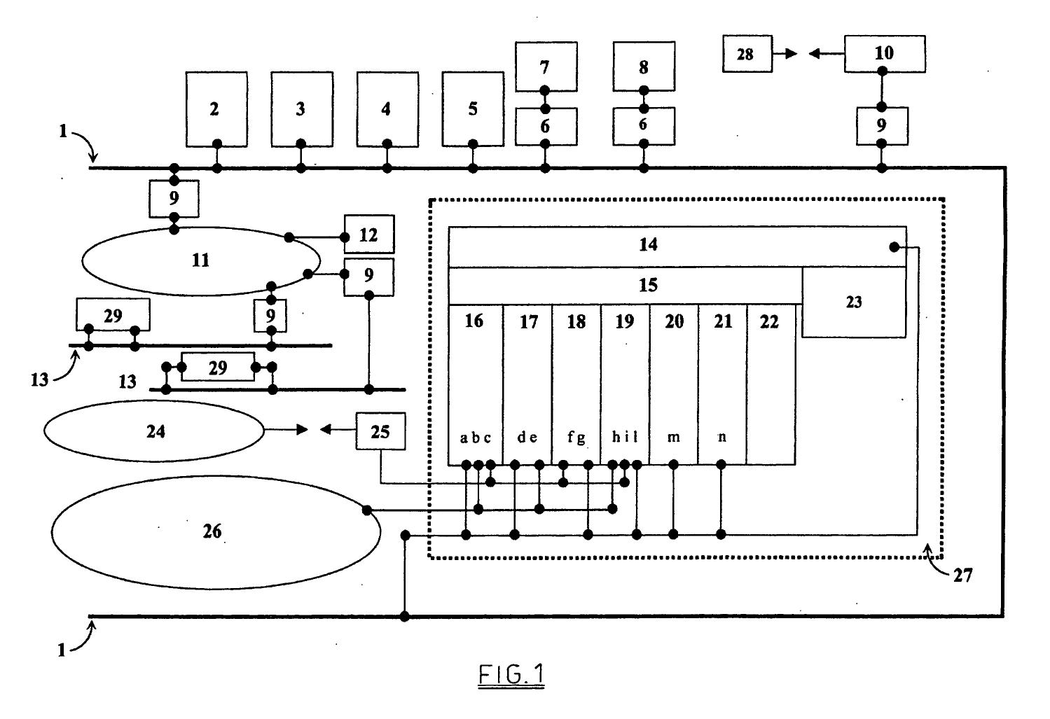

Referring now to FIG. 1, an apparatus (27) according to the invention, for the management of all types of communications, is connected to a LAN (1) that, in turn, is locally or remotely connected to the Communications Devices and Terminals, as well as other equipments, as indicated in the legend at the end of this description.

The LAN (1), to which the apparatus of the invention is connected, is linked, through the Internet (11), to other Local Area Networks (13) to which other devices and terminals (29) may be connected. Devices (12) fitted with headphones, microphones and web cameras as well as other Communications Devices and/or Terminals may be also individually connected to the Internet network (11).

The communications management apparatus (27) is connected to mobile telecommunications networks such as GSM, UMTS, etc. (24) through corresponding mobile Communications Devices or Terminals (25). The apparatus (27) is also connected to fixed telecommunications networks such as PSTN, ISDN, etc. (26) and may be further directly connected to satellite networks or other computer networks in general.

The apparatus (27) comprises a single processor that, from a hardware standpoint, can certainly be made up of one or more processing units in a joint or separate layout, that can operate in parallel only for the purposes of determining the resulting computing power, but from a software standpoint, uses a single set of procedures and a single multi-sector operating database. The above apparatus includes a section that houses said operating database, as well as several specific logical-functional sections made up of hardware and software components. In particular, the logical-functional sections are made up of:
A WEB SERVICES section (14) dedicated to using the Internet Web Browser to display on the visual display panels of each Communications Device or Terminal connected locally (2, 3, 4, 5, 7, 8, 10, 25) or remotely (28, 29, 12), specific interactive graphical interfaces (30) for initiating, receiving, controlling and managing all types of communications from said Communications Device and/or Terminal;
A COMMUNICATIONS KERNEL section (15) dedicated to support communications between the Communications Devices and/or Terminals connected to the LAN (1) and between said Communications Devices and/or Terminals and other Communications Devices and/or Terminals connected to communications networks in general, PSTN, GSM, UMTS, the Internet (26, 24, 11, etc.) as well as remote computer networks (13). This section is furthermore dedicated to checking and generating the storage in the database (23), of the historical data of the communications managed through the apparatus of the invention.
Sections (16 through 22) dedicated to interfacing the apparatus (27) with Communications Devices (PCs, PDAs, etc.) and Terminals (2, 3, 4, 5, 7, 8, 10, 25) locally or remotely (28, 29, 12) connected to the LAN (1) and to fixed (26) and mobile (24) telecommunications networks.

The logical-functional sections (16 through 22) are made up of communications channels that allow for dialogue between Communications Devices or Terminals connected locally (2, 3, 4, 5, 7, 8, 10, 25) and remotely (28, 29, 12) to fixed (26) and mobile (24) telecommunications networks, carrying out the conversions between the various communications protocols (H323, SIP, MEGACO or others) used by said devices. In particular, FIG. 1 shows:

the PCC—Phone Communications Channel dedicated to telephonic communications (16);

the FCC—Fax Communications Channel dedicated to facsimile transmissions (17);

the SCC—SMS/MMS Communications Channel dedicated to telephonic messages (18);

the VCC—Video Communications Channel dedicated to video and multimedia communications (19);

the CCC—Chat Communications Channel dedicated to real time communications via the computer (20);

the MCC—E-Mail Communications Channel dedicated to e-mail messages (21); and lastly,

one or more channels dedicated to other types of communications (22).

The logical-functional CK (Communications Kernel) section (15) dedicated to supporting communications, routes outbound communications towards the communications channels (16 through 22) on the basis of the communications protocols stored in the storage section (23), receives inbound communications through the related communications channel and then routes them to the addressee Communications Device and/or Terminal in function of the settings associated with the addressee, as stored in the storage section (23). At the same time, the CK logical-functional section (15) activates the WS (Web Services) logical-functional section (14).

The central processor or Network Server (27) is directly connected to the LAN (1) and to the other communications/telecommunications networks such as PSTN (26), MOBILE (24), INTERNET (11), etc.

All the fluxes of all the types of inbound and outbound communications must necessarily pass through the device that incorporates the central processor or Network Server (27) and therefore, the Server is the only device that generates a log of any type of inbound or outbound communication involving the Communications Devices and/or Terminals connected locally to the LAN (1) or remotely to other LANs (13), or interconnected via the Internet (11) or involving other communications and telecommunications networks such as PSTN (26), the MOBILE NETWORK (24), etc.

The single software programme installed on the Server (27) is divided into three separate modules below, solely in order to better illustrate its functions, although it remains a single entity in functional terms. This software allows for the initiation, reception, monitoring, control and management of all types of communications through the Internet Web Browser via the Toolbar (30) that is part of the method of the invention.

The sections and logical-functional sections, apart from the Database, are indicated below:
WEB SERVICES HTTP/XML (14)
COMMUNICATIONS KERNEL (15) and DATABASE (23)
COMMUNICATIONS CHANNELS (16, 17, 18, 19, 20, 21, 22)

The most common types of communications networks supported by the COMMUNICATIONS CHANNELS and certain protocols used by each communications channel of the invention, are listed below.

| COMMUNICATIONS | Communications | |
|---|---|---|
| CHANNEL | NETWORKS | STANDARDS/PROTOCOLS |
| Phone channel | LAN/INTERNET | H.323, SIP, RTP, G.711, |
| | | G.726, GSM vocoder, Speex, |
| | | G.729, etc. |
| | PSTN, ISDN | Q.931, LDAP, (POTS, ISDN |
| | | BRI, ISDN PRI etc.) |
| | MOBILE | GSM, UMTS |
| Fax Channel | LAN/INTERNET | T.38 |
| | PSTN | V.17, V.27, V.29, V.33 |
| Sms-Mms Channel | LAN/INTERNET | HTTP, XML |
| | MOBILE | GSM, GPRS |
| Video Channel | LAN/INTERNET | H.323, SEP, RTP, RTCP, |
| | | H.261, H.263 |
| | PSTN, ISDN | H.320 (ISDN BRI, ISDN |
| | | PRI etc.) |
| E-mail Channel | LAN/INTERNET | POP, IMAP, SMTP |
| Chat Channel | LAN/INTERNET | HTTP, XML |

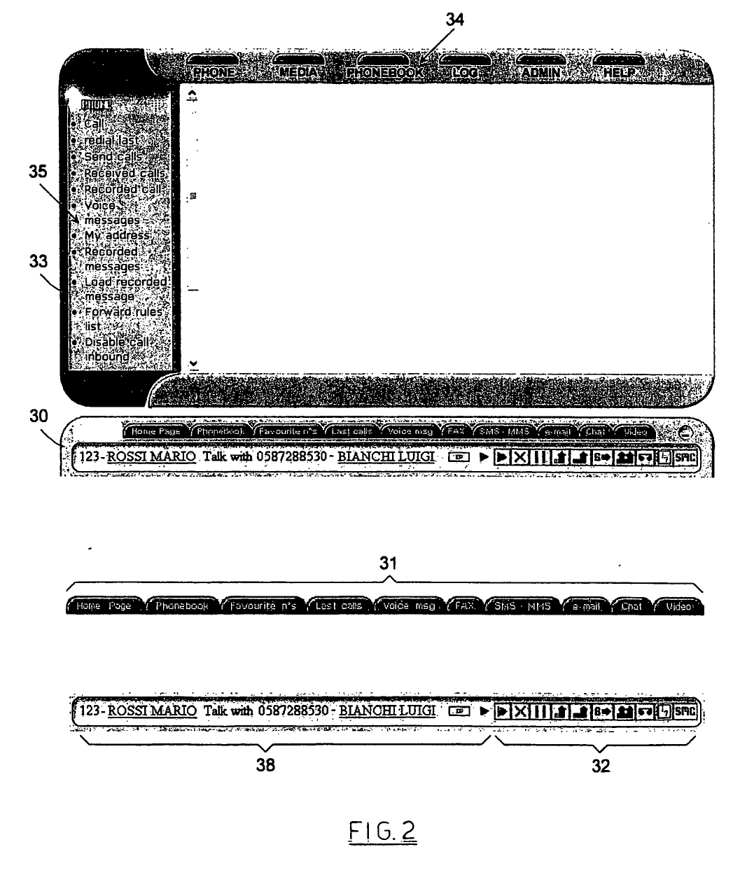

The WEB SERVICES section (14) uses the Browser Toolbar (30) shown in FIG. 2 to display the visible and interactive graphical interface on the visual display panels of the Communications Devices and/or Terminals connected to the LANs, using interaction typical of the Web.

The COMMUNICATIONS KERNEL section (15) is the heart of the software functional unit used by the apparatus of the invention for all types of communications management and is made up of a Central Electronic Processor or Network Server (27). The COMMUNICATIONS KERNEL section (15) contains the logical-functional sections (14, 15, 16, 17, 18, 19, 20, 21, 22, 23) and performs all the automatic and manual functions pertaining to all types of communications management by routing communications towards and between the various COMMUNICATIONS CHANNELS (16, 17, 18, 19, 20, 21, 22), while also generating a log of the communications by interfacing with the Database (23).

Each COMMUNICATIONS CHANNEL (16, 17, 18, 19, 20, 21, 22) manages one or more communications protocols (for instance: H323, ISDN, SIP, MEGACO, T38, etc.) carrying out the required conversions of said protocols, so as to allow different networks and protocols to dialogue with each other. In the case of outbound calls the related Communications Devices and/or Terminals (2, 3, 4, 5, 7, 8, 28, 29, 10, 12, etc.) activate the relevant COMMUNICATIONS CHANNEL and in the case of inbound calls, the relevant COMMUNICATIONS CHANNEL enables the related Communications Devices and/or Terminals (2, 3, 4, 5, 7, 8, 28, 10, 12, 29, etc.), so as to allow the user to take fully manage all his communications.

The WEB SERVICES section (14) that is prompted automatically or manually (through the Web Browser Toolbar (30)) to interact with the COMMUNICATIONS KERNEL section (15) that is, in turn, in communication with the various COMMUNICATIONS CHANNELS (16, 17, 18, 19, 20, 21, 22,) and the DATABASE (23), automatically displays all the information pertaining to the initiation, reception, control and management of overall communications, as well as the related information stored in the Database (23), on the visual display panels or monitors of the Communications Devices and/or Terminals (2, 3, 4, 5, 7, 8, 28, 10, 12, 29, etc.) in question.

The WEB SERVICES section (14) enables the initiation, reception, control and management of overall communications both in the case where they are initiated from the aforesaid COMMUNICATIONS DEVICES and TERMINALS (2, 3, 4, 5, 7, 8, 10, 25) directly connected to the LAN (outbound calls, faxes, sms, etc.) and in the case where they originate from outside networks such as the fixed PSTN (26) or MOBILE (24) telecommunications networks (inbound call, faxes, sms, etc.) or from Communications Devices and/or Terminals (29) associated with other remote LANs (13) (inbound calls, faxes, chats, etc.) connected via the Internet (11) or even from Communications Devices and/or Terminals connected via satellite (28) or the Internet (12).

The aforesaid toolbar graphic (30) is shown in the upper part of FIG. 2, just as it appears on the visual display panels of the Communications Devices and/or Terminals connected to the LAN (1), remote networks (13) or directly tot the INTERNET (12).

A more detailed illustration of the said toolbar is provided in the lower part of the figure, showing two different types of icons (31, 32) that respectively provide access to the Database (31) managed from the device incorporating the Network Server (27) and enable the operating functions of said apparatus dedicated to the control and monitoring of inbound telephone calls or calls in progress (32). A further section (38) provides data pertaining to the caller, the party called as well as other data pertaining to the call.

All the icons (31) that appear in the upper portion of the toolbar (30) and that are enlarged, provide access to sections of the Database (23) such as a phone book, the log of calls recorded on the answering machine, the log of faxes received, the log of SMS or MMS messages, the log of e-mails received, the log of video calls or video conference calls as well as other databases stored in the storage section (23) of the processor (27).

It has to be noticed that selecting a given icon (31) not only provides access to the corresponding database (in function of the access privileges assigned to the user), but also enables a procedure that, under the control of the section (15) of the device, allows for the performance of direct commands based on the data retrieved from the Database and displayed on the visual display panels of the Communications Device and/or Terminal through which the icon was selected. In other words, selecting a given icon (31), displays on the visual display panels of the Communications Devices and/or Terminals (2, 3, 4, 5, 7, 8, 10, 12, 28, 29) further graphical interfaces that can display the data stored in the section of the Database (23) associated with the icon to carry out commands for the initiation, reception, control and management of any type of communication.

The first icon to the left, Home Page, in particular, not only opens the graphical interface (33) shown in the upper part of FIG. 2 that displays a section of the Database (23) that affords access to other sections of the Database (23) through icons located in the area (34), but also enables an outbound call to be dialled or activates other functions offered by the apparatus, as indicated in the area (35).

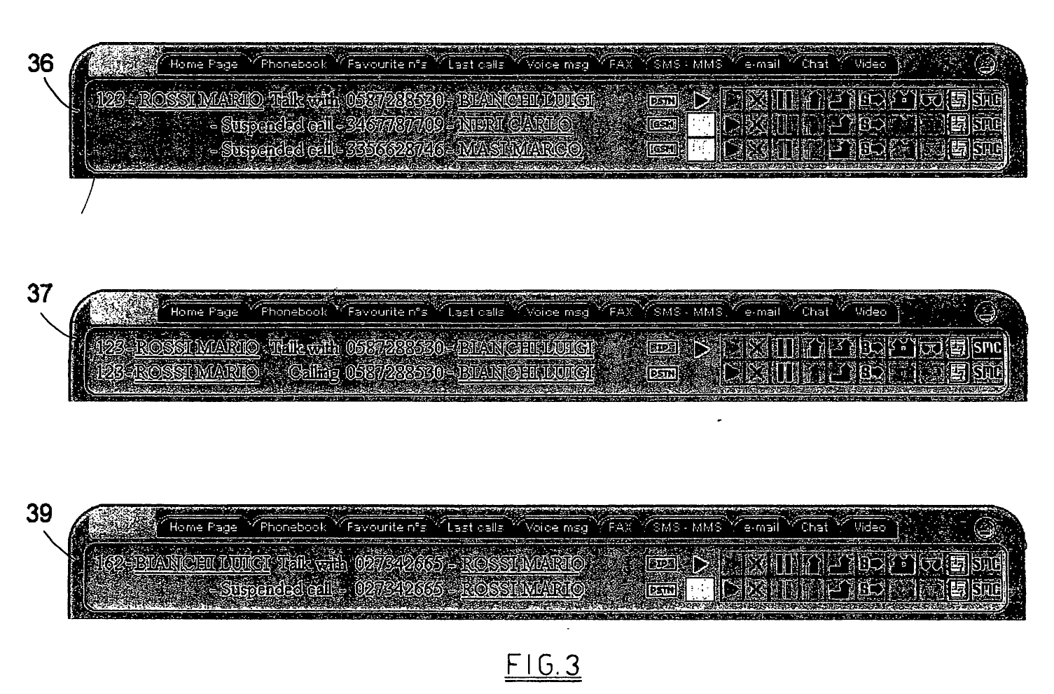

The icons (32) that appear to the right of the toolbar (39) enable commands to be imparted to the apparatus including the Network Server (27) so as to allow for full control of all outbound and inbound communications, including communications already underway—These icons are in fact repeated in the toolbar for each of the communications that at any given moment may involve a specific Communications Device and/or Terminal connected to the LAN (1) either locally (2, 3, 4, 5, 7, 8, 10)) or remotely (28, 29, 12). Three different examples of toolbars (36, 37 and 39) associated with possible combinations of the said communications are shown in FIG. 3. Certain specific functions that can be used for the types of communications that require control and management in real time, such as, for instance, telephone calls, video calls etc., are listed below.

The first icon from the left of the aforesaid icons (32), for instance, is used to enable a procedure that transfers the user to a waiting call or a call that was previously forwarded to another number;

the second icon, featuring two crossed bars, is used to disconnect the communication underway;

the third icon, featuring two parallel vertical bars, is used to put the call on hold;

the fourth icon from the left, feature an arrow with vertical lines, is used to transfer the call subject to acceptance of the inbound call by another number on the network;

the fifth icon from the left, featuring an arrow, is used to directly transfer the call to another number on the network;

the sixth icon from the left, feature the letter “S” and an arrow, is used to transfer the call to the telephone or video answering machine;

the seventh icon from the left, featuring a double arrow, is used to enable the connection of more than two users in a telephone or video conference call;

the eighth icon, featuring the symbol of a recorder, is used to enable the recording of a telephone or video call or multimedia communication between two or more users;

the second last icon from the right, is used to allow the user to search even remote web-based Databases for information, on the basis of the user's specific requirements;

the last icon, bearing the letters “SMC”, is used to enable the manual initiation of one or more alternative calls towards one or more addressees, at the same time.

The apparatus can cause the display of several interactive toolbars (30) on the visual display panels of the Communications Devices and/or Terminals, up to a maximum pre-set number, each toolbar being used for the management of one of the inbound or outbound calls, or even, communications pertaining to interactions of said Communications Devices and/or Terminals, as illustrated in FIG. 3.

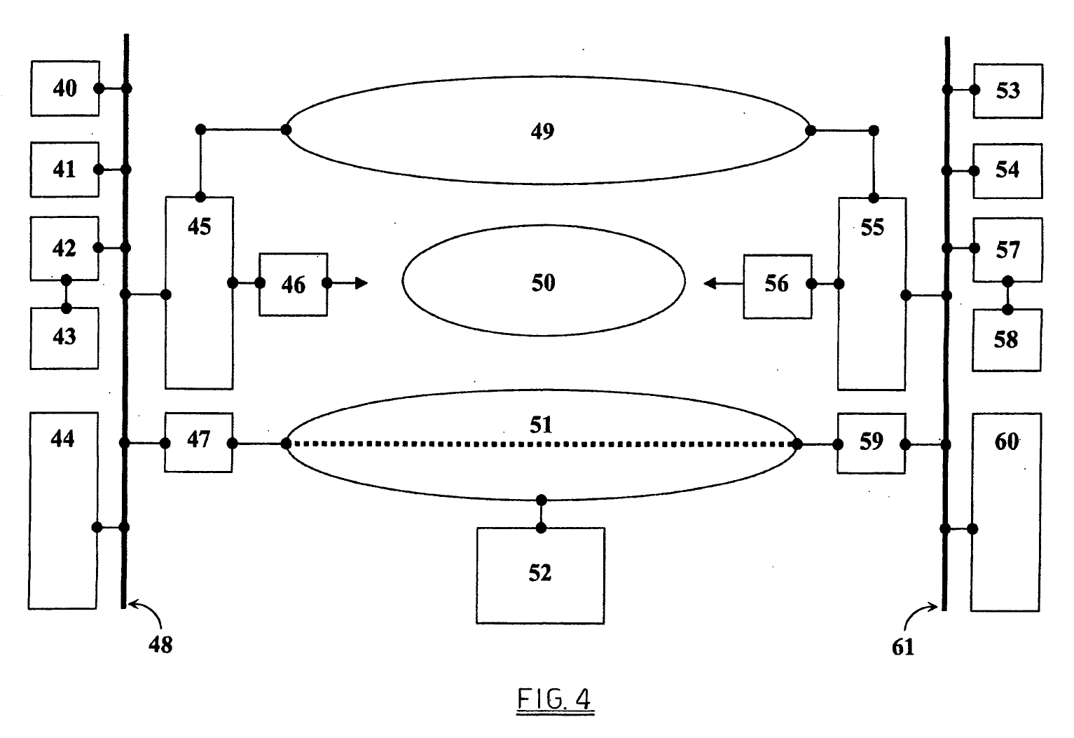

Detailed legends to FIGS. 2 and 3 referred to above, as well as FIG. 4 described below, are provided at the end of this description.

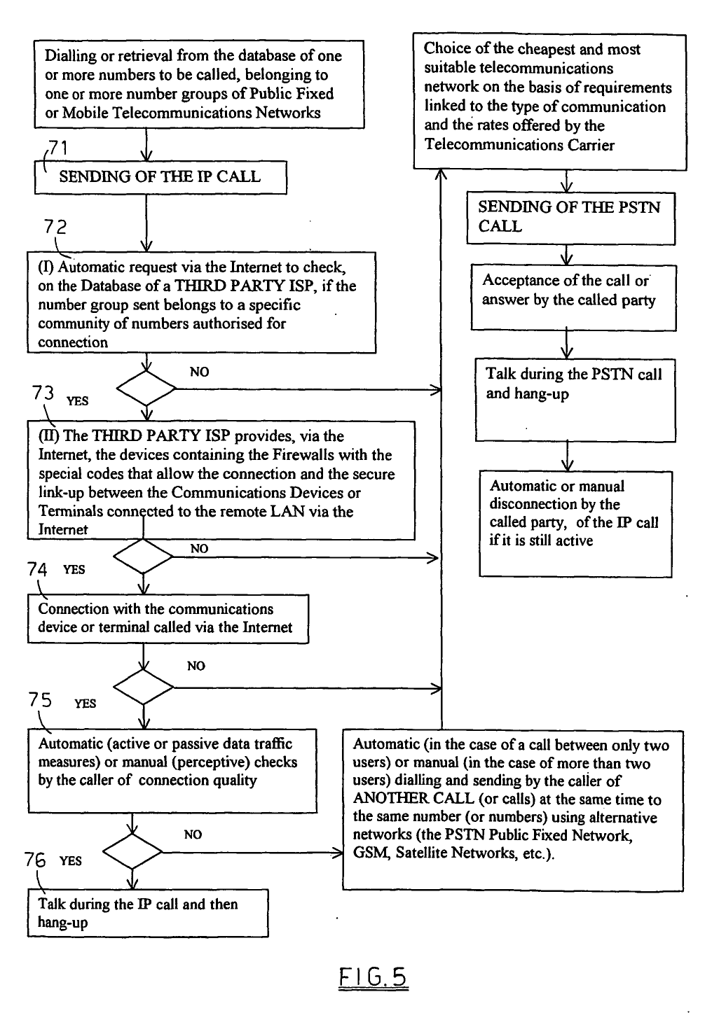

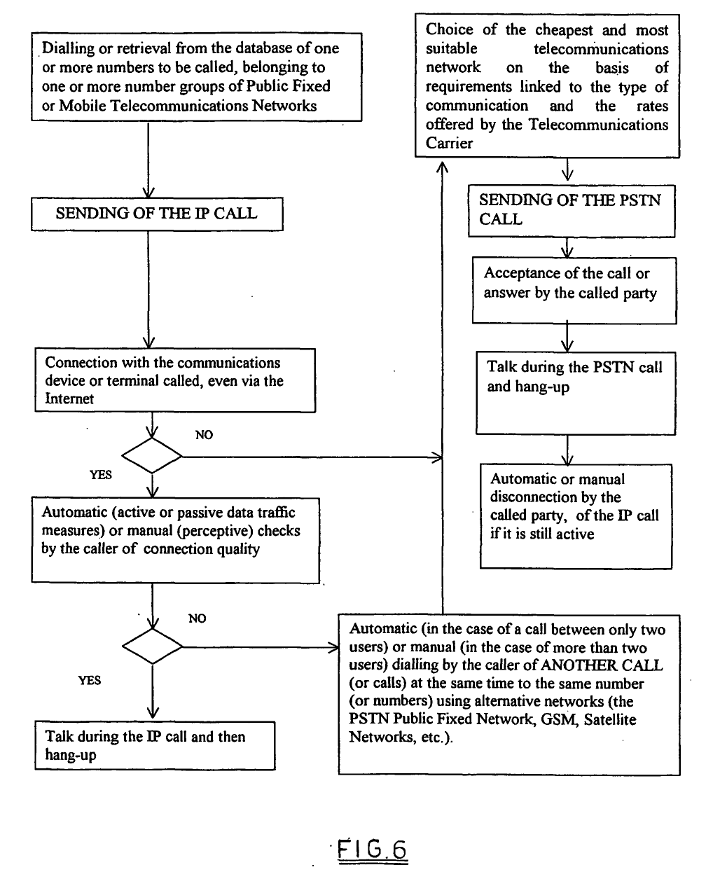

FIG. 4 shows a block diagram of an example of communications modes between two LANs (48, 61) that are interconnected through different types of public or private communications networks, such as the Internet (51), a fixed public telecommunications network PSTN, ISDN, etc. (49), or a mobile public telecommunications network GSM, UMTS, etc. (50). Several communications devices and/or terminals are connected to each of the two LANs, and thanks to the method and apparatus of this invention, said communications devices and/or terminals can communicate with each other in different ways, as explained in greater detail below and summarised in the flowcharts of FIGS. 5 and 6.

An indicative but not exhaustive description of how the above described apparatus works, is provided below, with reference to three examples of manageable communications, a), b) and c).

a) Call made by a user of a Communications Device and/or Terminal (2, 3, 4, 5, 7, 8, 12, 28) connected to the Local Area Network (LAN) (1) either directly (2, 3, 4, 5, 7, 8) or remotely (12, 28, 29), even through other Local Area Networks (LANs) (13), to another user of a Communications Device and/or Terminal (2, 3, 4, 5, 7, 8, 12, 28) connected to the Local Area Network (LAN) (1) either directly (2, 3, 4, 5, 7, 8) or remotely (12, 28, 29), even through other Local Area Networks (LANs) (13). All the LANs belong to the same group or corporation.

The logical-functional WEB SERVICES section (14) causes the Communications Device and/or Terminal to display the Web Browser toolbar (30) incorporating interactive icons that provide a graphic presentation of all the ways in which the user can manage his overall communications, including this call. It has to be noticed that the Database stored in the section (23) contains, amongst other things, a list of the options or privileges assigned to each Communications Device and/or Terminal with a local or remote LAN connection. It must further be noticed that the Web Browser software programme, through which the user can access all the available communications management options, is loaded manually or automatically when the Communications Device and/or Terminal is switched on. The IP addresses of communications terminals (3, 7, 8) may be used to associate a single device (2, 4, 5, 12, 28) with one or more terminals connected to the same LAN or to other LANs (13), and conversely, a single communications terminal (3, 7, 8) may be associated with several devices (2, 4, 5, 12, 28).

The toolbar that appears on the visual display affords the user access to all the operating functions available through the WS section, such as, for instance, the phone book, the window showing outbound calls, call management, conference call, and automatic recall as well as to new functions through which the user can, for instance, make, receive, control and manage calls through his Communications Device and/or Terminal, and also provides an indication of the type of communications network or the communications protocol, IP in this case (30).

The user then places the call using the mouse, touch screen or keyboard of the Communications Device and/or Terminal (2, 3, 4, 5, 7, 8, 12, 28), and in doing so, triggers interaction between the WS section (14) and the CK section (15).

Using information retrieved from the Database (23), the CK section identifies one or more Communications Devices and/or Terminals and sends a series of data to the PCC section (Phone Communication Channel) (16). This also causes the Database to store a record of the historical data of the call, such as, for instance, the date, time, the ID of the caller as well as the party or parties called and several other data.

Using the port (16a) that connects the Communications Device and/or Terminal to the LAN (1), the PCC section (16) transfers call-specific information, such as, for instance, the ID of the caller and the party called, and starts generating a ring at the one or more of the Communications Devices and/or Terminals to which the call is placed.

The PCC section also notifies the CK section (15) of the status of the communications device or terminal to which the call is made, such as for instance, call in progress, device/terminal connected, device/terminal busy, no answer, etc. Depending on the status of the Communications Device and/or Terminal, the CK section may be able to once again send the PCC section automatic commands on the basis of information stored in the Database, such as, for instance, call forwarding or the setting for automatic recall, etc., or may perform the commands manually input by the users of the Communications Devices and/or Terminals at the caller's or the called party's end.

At the end of the call, the CK section (15) notifies the WS section (14) of the information pertaining to the caller, the party or parties called, the IP address, the date, the exact time of the call down to the second, and the duration of the call, so that all these data can be displayed on the devices/terminals involved or enabled. Furthermore, the CK section transmits the data to the storage section (23) that houses the Database.

The system therefore allows for full call management in a real CTI (Computer Telephony Integration) environment. The same manual commands used to place and manage calls can be input into the system using solely the keyboards of Communications Devices and/or Terminals devoid of visual displays, including analogue telephones (7).

b) Call originating from a user of a public mobile telecommunications network, GSM, UMTS (24) to a user of a Communications Device and/or Terminal connected to the LAN (1) either directly (2, 3, 4, 5, 7, 8) or remotely (12, 29), via the Internet, another LAN (13) or other networks (28).

The call originating from a user of the mobile telephony network (24) reaches the PCC section (16) of the central processor (Network Server 27), to the connection port (16b) in the case where the caller has dialled a telephone number belonging to a public fixed telephony network PSTN, or to the connection port (16c), through the mobile Communications Device and/or Terminal (25), in the case where the caller has dialled number belonging to the public mobile telephony network of a Mobile Communications Terminal (25) connected to the central processor or Network Server (27).

The PCC logical-functional section (16) transfers the information contained in the telephone call, such as for instance, the identity of the caller and the number called, to the CK section (15) that then routes the call to the addressee Communications Device and/or Terminal, after selecting the most suitable communications channel for the call on the basis of the settings associated with the addressee and stored in the storage section (23).

The CK logical-functional section (15) at the same time enables the WS logical-functional section (14) and prompts the Database (23) to generate and store a historical log of the call.

At this point, the apparatus continues as indicated in point a) above, to provide for full management of the call.

c) Telephone call placed by the user of a Communications Device and/or Terminal (40, 41, 43, 44) connected to the LAN (48) to a user of a Communications Device and/or Terminal (53, 54, 58, 60) connected to a LAN (61) in a remote location. The LANs in question (48, 61) do not belong to the same group or corporation but both use the method and apparatus of the invention.

It must first of all be pointed out that the two or more LANs (48 and 61) are linked through a high-speed Internet connection (51) and use the related protections offered by an Intelligent Apparatus containing a Router and a Firewall (47) for the LAN (48) as well as an Intelligent Apparatus containing a Router and a Firewall (59) for the other LAN (61). Furthermore, both the aforesaid LANs (48 and 61) are also connected through public and private communications networks for fixed telecommunications and video communications (49) such as PSTN, etc., and communications networks for mobile telecommunications and video communications (50) such as GSM, UMTS, SATELLITE NETWORKS, etc. The networks (49) and (50) are connected directly to the apparatus (45) and (55) that are identical in all aspects to the apparatus (27) shown in FIG. 1 and described in depth above. These apparatuses are in turn connected, respectively, to the LANs (48) and (61). From this point onwards, reference will also be made to FIG. 1, since the apparatuses (45) and (55) feature the same logical functions of the apparatus (27) shown in FIG. 1.

The WS logical-functional section (14) of the apparatus (45) causes the Internet Web Browser toolbar (30) to appear on the visual display panel of the Communications Device and/or Terminal (41, 44) of the caller (40, 41, 43, 44), providing the caller with a graphic presentation of all the functions available to the user for managing his overall communications, including this call. It must be pointed out that the Database stored in section (23) contains, amongst other things, the list of options and privileges assigned to each Communications Device and/or Terminal connected to the LANs (41, 61).

It has to be noticed, furthermore, that the Web Browser software programme through which the user can access all the available communications management options, is loaded manually or automatically when the Communications Device and/or Terminal is switched on. The IP addresses of communications terminals (40, 43, etc.) may be used to associate a single device (41, 44) with one or more terminals connected to the same LAN (48) and conversely, a single communications terminal (40, 43, etc.) may be associated with several devices (41,44) connected to the same LAN.

The toolbar that appears on the visual display affords the user access to all the operating functions available through the WS section, such as, for instance, the phone book, the window showing outbound calls, call management, conference call, and automatic recall, as well as to new functions through which the user can, for instance, make, receive, control and manage calls through his Communications Device and/or Terminal. One such function involves the management of multiple calls at the same time, using an alternative communications network, aimed at the same user to whom a call was previously placed. To avoid confusion, “IP” will be used to denote the first call, “PSTN” to denote the second call alternative to the first and “CN” to denote any later alternative calls.

The IP call may be placed using the mouse, touch screen or keyboard of the Communications Device and/or Terminal (40, 41, 42, 44) connected to the LAN (48) to the Communications Devices and Terminals (53, 54, 58, 60) connected to the LAN (61), but to keep this explanation simple, mention will here be made only of the telephone call, starting with the IP call placed through a single Communications Terminal (40) associated with the Personal Computer-Device (41) to a single Communications Terminal (53) associated with a Personal Computer-Device (54).

The telephone call can be placed in various ways such as: by dialling the called party's telephone number using the keyboard of the Terminal (40) or Device (41) or with the click of a mouse or using the touch screen. Placing the call in any one of these ways will trigger interaction between the WS section (14) and the CK section (15).

Using information retrieved from the Database (23), the CK section (15) identifies one or more fixed, mobile or satellite or other telephony numbers belonging to the Communications Terminal (53) and sends a series of data to the PCC section (Phone Communications Channel) (16). This also causes the Database to store a log of the historical data of the call, such as, for instance, the date, time, the ID of the caller as well as the party or parties called and several other data.

Using the connection port (16a) to the LAN (48), the PCC section (16) transfers the information contained in the IP call, such as, for instance, the ID of the caller and the party called and other data, through the intelligent apparatus containing the Router and Firewall (47) via the Internet (51) to a THIRD PARTY Internet Service Provider (52) that, after having checked its database to ensure the caller's entitlement to the Internet connection to telephone numbers called by the caller (40), communicates a transmission code to the devices (47) and (59), so as to allow for secure access and the continuation of the communication via the Internet, between the local LANs (48) and (61), such communication being represented in FIG. 4 by a BROKEN LINE within the Internet network (51).

The PCC section (16) of the apparatus (55) then generates a ring signal at the Communications Terminal (53) to which the call was placed, and the WS section (14) of the said Device causes the Toolbar (30) to be displayed on the Visual Display Panel of the Apparatus (54) associated with the aforementioned Communications Terminal (53).

The PCC section (16) furthermore informs the CK section (15) of the status of the addressee communications terminal (53), such as for instance, call in progress, line connected, busy, no answer, etc.

In light of the status of the Communications Terminal (53), the CK section (15) may then once again send the PCC section automatic commands generated on the basis of the information contained in the Database, such as for instance, call to be redirected, automatic dialling of a later call, or other instructions, or the user of the Communications Terminal (53) can issue manual commands on the basis of the privileges assigned to him.

At the end of the call, the CK section (15) notifies the WS section (14) of the information pertaining to the caller, the party or parties to which the call was made, the date, and exact time to the last second of the call and the duration of the call, so that these data can be displayed on the visual display panels involved or enabled. Furthermore, these data are transmitted to the CK section (15) and the data storage section (23) that houses the Databases of the apparatuses (45) and (55).

The system therefore allows for full call management in a real CTI (Computer Telephony Integration) environment. In such regard, it must be noticed that the same manual commands for placing and managing calls through the toolbar (30) can also be input into the system using solely the keyboards of Devices (41, 54) and the Communications Devices and/or Terminals devoid of visual displays (40, 53). Moreover, the call can be placed even in multiple call mode and therefore from one caller unit to several called units.

It must further be noticed that all the data are stored not only in the Database of apparatus (45) as an outbound communication, but also in the Database of apparatus (55) as an inbound communication.

Up to this point, we have examined a successful link, that is to say, the first IP call went through properly and the caller was informed that an IP call had been made by the appearance of the related IP icon in the right-hand portion of the data section of the Toolbar (38).

However, in some cases, communications or video communications via the Internet may encounter difficulties in terms of securing the connection with the party called or reaching the acceptability threshold during transmission as a result of interruptions in the data transmission service. In fact, we have to remind that IP is a BEST EFFORTS protocol that does not guarantee high quality service.

To overcome this problem, both during the connection phase and during the communication itself, we can obtain, according to the method and apparatus of the invention, an automatic or manual check of the quality of the Internet connection (51), and, on the basis of the results of this check, a simultaneous enabling of one or more calls from the caller (40) to the party called (53) using both the same communications network (51) as well as one or more communications networks (49, 50, etc.) that serve as alternatives to the communications network (51) used for the first call.

The flow chart in FIG. 5 shows the process for the functional macro-areas pertaining to: the placement of the call (71), authentication of the ISP (72), opening of a secure connection (73), connection to the Communications Device or Terminal (74), check of the quality of the connection (75) and lastly, the successful completion of the call (76). To understand this in practical terms, it must be noted that “IP” denotes the first call placed using the high speed Internet connection, while “PSTN” denotes the consequential or simultaneous call that uses one or more alternative networks such as PSTN, GSM, UMTS or even satellite networks. If the IP communication fails to reach its addressee, the alternative PSTN call is automatically enabled immediately. The PSTN call may be placed automatically or manually even if the IP call is already underway since, according to the method and apparatus of the invention, a user can initiate, receive, monitor and manage more than one call at the same time from all the Communications Devices and/or Terminals (40, 41, 43, 44) connected to the LAN (48), and moreover, all the Communications Devices and/or Terminals (53, 54, 58, 60) connected to the LAN (61), can send, initiate, receive, monitor and manage more than one communication (multiple communications and queue management through the visual display panels of the Communications Devices and/or Terminals in question).

The manual management and display of the alternative, simultaneous PSTN call that occurs when the service quality of the IP call is unsatisfactory, is described below. Assuming the situation above, and that is to say, the IP call is placed from the Communications Terminal (40) associated with the Personal Computer (41) to the party called (53) associated with the Personal Computer (54), it must be noted that the WS logical-functional sections (14) of the apparatus (45) and (55) that cause the visual display panels of the devices (41) and (54), respectively, to display the Internet Web Browser toolbar (30) that provides a graphic menu of all the functions available to the user to manage more than one inbound or outbound communication (32). The further PSTN call can be placed by using the mouse of the Personal Computer (41) to click on the SMC icon of the toolbar (30) or by using the touch screen or typing out the number on the keyboard of the Device (41) or through the Communications Terminal (40).

This triggers interaction between the WS section (14) and the CK section (15). The CK section (15) uses the data stored in the Database (23) to identity one or more fixed, mobile, satellite or other telephony numbers belonging to the Communications Terminal (53) and sends a series of data to the PCC (Phone Communications Channel) section (16). As in the case of the IP call, this causes the Database to generate a log of the historical data of the PSTN call, that records information such as, for instance, the date and time of the call, the ID of the caller and the called party or parties, or still other data generated by simultaneously enabling a special call function known as SIMULTANEOUS MULTIWAY COMMUNICATION (SMC) that simultaneously enables two or more calls from the same Communications Device or Terminal, that is to say, the IP and PSTN (37) calls in this example.

In light of the telephone number called and the reset parameters, the CK section searches the Database (23) to identify the cheapest and most suitable communications transport network and carrier available for the call and then routes the call through the connection port linked to the PSTN network (16b) or the connection port linked to the GSM, UMTS mobile telecommunications network (16c) or the satellite network.

The PCC section uses the ISDN, GSM, UMTS etc. transmission protocols to ascertain the type of telephonic signal (ISDN, GSM, UMTS etc.) received and then generates a signal informing the party called (53) of the arrival of the further PSTN call through the selected alternative communications network, such as PSTN (49) or GSM, UMTS (50) or a satellite network. Furthermore, the PCC section also notifies the CK section that activates the WEB SERVICES section (14) that causes the Toolbar (37) that appears on the visual display panels of the devices (41, 54) to indicate the STATUS of the caller's (40) and the called party's (53) telephone terminals, such as, for instance, in this case, phone ringing, line busy, call connected, etc.

The visual display panel (54) at the caller's end (53) will then display a second toolbar showing the PSTN icon (39) that remains suspended until the called party (53) interacts with the mouse of the Personal Computer (54) to take the said suspended called and to abandon the IP call, the quality of which was unacceptable. At the end of the call, the CK section (15) notifies the WS section (14) of the data pertaining to the caller, the called party or parties, the date and exact time of the call up to the second and the duration of the call, so that these data can then be displayed on the visual display panels involved or enabled. Moreover, these data are transmitted from the CK section to the storage section (23) that houses the Databases of the relevant apparatus (45) and (55).

It must also be pointed out that in the case of communications between Communications Devices or Terminals connected to LANs that may be remote from one another but that belong to the same group or corporation, as in the case of call a), the connection to the THIRD PARTY Internet Service Provider (52) is not activated insofar as it is not necessary since the telephone number of the party called is already stored in the Database (23) of the apparatus (27).

This is illustrated in the flow chart of FIG. 6 that is analogous to that one of FIG. 5 for the management of simultaneous multiple communications over communications networks other than that used for the initial communication

It is obvious that the method, and apparatus, of the invention is applicable and provides the same functions as those described above in the examples of telephonic communications, even in respect of other types of communications, such as TELEPHONE calls in general, FAXES, SMS and MMS, VIDEO messages, E-MAILs, CHATs and MULTIMEDIA communications in general. Using the interfacing sections (16, 17, 18, 19, 20, 21, 22) most suited to the type of communication on a case-by-case basis, the apparatus of the invention, that includes a central processor or Network Server (27), therefore avails of an Internet Web Browser to enable, control and manage, in keeping with the principles described above and illustrated in the examples that focus solely on telephone calls, overall inbound and outbound communications regardless of whether they are made on an individual basis or in multiple communications mode, even amongst themselves, within or outside the local network (1).

The method and apparatus of the invention therefore sets up a constant communications bridge between various telecommunications networks and their respective protocols, using a single software programme that has been described in terms of functionally distinct sections and channels solely for the purpose of better illustrating the invention. Furthermore, the invention uses a single database that automatically stores the files and logs pertaining to all communications fluxes that interact with the COMMUNICATIONS KERNEL.

Given that the initiation, reception, control and management of overall telecommunications and multimedia communications is undertaken using an Internet Web Browser (30) that interacts with the central processor or Network Server (27) connected to the LAN (1), it follows that overall telecommunications and multimedia communications can be enabled, controlled and managed in exactly the same manner both in the LOCAL LAN (1) ENVIRONMENT and in REMOTE, using STAND ALONE Communications Devices and/or Terminals or Communications Devices and/or Terminals connected (29) to LANs (13) situated in remote locations, provided that both the stand alone and LAN-connected Communications Devices and/or Terminals, are connected to the LAN (1) through ADSL connections or other similar Internet technologies (11).

In other words, taking the example of the telephone call “a” illustrated above, the apparatus and the method of the invention ensure that there are no differences in terms of the management procedures, quality, time required and costs involved, between a telephone call placed from a communications terminal locally linked to the central processor or Network Server (27), through the LAN (1) and a telephone call placed from a Communications Device or Terminal (12, 29) that is located thousands of km away from the LAN (1) and, therefore, also far away from the central processor or the Network Server (27), but connected to the LAN (1) using an ADSL Internet connection (11). This feature allows for all types of communications to be enabled, received, controlled and managed even from and between remote Communications Devices and/or Terminals (29) that are either stand alone machines (28, 12) or machines linked to the remote network (13), exactly as if they were locally connected to the LAN (1), since the said remote devices can be connected, for instance using Internet ADSL or similar technology (11), to the central processor or the Network Server (27) and can therefore be treated as though they were in fact interconnected.

The benefits in terms of flexibility, operating potential and management capacity of all types of communications involving a given computer network comprising an apparatus according to the invention, are obvious.

Furthermore, thanks especially to the method in which the Internet Web Browser is used, the apparatus described above, allows for Communications Devices and/or Terminals connected to the local network to which the apparatus itself is connected, or to telecommunications and computer networks linked to the local network, even via the Internet, to be easily enabled, disabled, identified or subjected to any other management procedure.

Taken together, the above features allow for efficient management of all types of communications over interlinked communications networks, since, on the one hand, by using the computer potential of the networks, they provide an innovative way of “managing” the communications themselves, ensuring that all communications are fully under control and visually displayed even while they are underway and allowing the user to effect simultaneous parallel communications to the same party called, and on the other, they continue to provide the greatest possible flexibility in terms of installation, dismantling or assignation of privileges by a Systems Administrator to individual users, regardless of the hardware/software platform of the Communications Device and/or Terminal with which said individual users are associated.

There can be no doubt that these features and benefits will remain unaltered even if changes or variations are brought to the example under consideration.

For instance, the number and type of operating functions available to individual Communications Devices and/or Terminals may vary, resulting in changes to the layout of the toolbar that the WS display section (14) causes to appear on the visual display panel of the said device.

The invention may also be subjected to other changes and modifications without the risk of falling outside the scope of protection of the inventive idea defined in the claims set forth below.

### Acronyms

ADSL—Asymmetric Digital Subscriber Loop; BRI—Basic Rate Interface; GPRS—General Packet Radio Service; GSM—Global System for Mobile Communications; HDSL—High-speed Digital Subscriber Loop; HTTP—HyperText Transfer Protocol; IMAP—Internet Message Access Protocol; ISDN—Integrated Services Digital Network; ISP—Internet service Provider; POP—Point Of Presence; POTS—Plain Old Telephone Service; PRI—Primary Rate Interface; SIP—Session Initiation Protocol; SMTP—Send Mail Transfer Protocol; UMTS—Universal Mobile Telecommunications System; XML—Extensible Markup Language

### Glossary

ANALOGIC PHONE or ANALOGIC TELEPHONE—Common voice communications terminal (POTS) operating on the public fixed telecommunications network PSTN.

ATM—Asynchronous Transfer Mode, system for the transfer of data structured in cells.

CHAT —“Conversation” using interactive video text in real time, between several people over the internet or other electronic networks.

CLICK—Action of pressing on a button of the mouse.

CLIENT—Term indicating a PC or other communications terminal connected to a Central Processor or Network Server through a LAN, WAN or the Internet.

CIRCUIT SWITCHING—Technique used in communications networks in which a physical connection is set up, maintained and terminated for each communications session.

COMMUNICATION STANDARD—Universally adopted rules, protocols and operating procedures, defined by international organisations and used in various communications infrastructure such as telecommunications networks, electronic networks, network devices, and communications devices and terminals in general.

COMMUNICATIONS PROTOCOL—Set of shared rules designed for standardising activities aimed at transferring or managing information. Examples include: H323, SIP, MEGACO, RTP, POTS, ISDN BRI, ISDN PRI, GSM, UMTS, T38, V27, HTTP, XML, IMAP, SMTP.

COMMUNICATIONS TERMINAL—Device capable of locally managing the type of communication for which it is enabled. For example, the telephone manages phone communications, the modem manages data transmission, the fax machine allows for the transmission of fixed images, etc.

CTI—Computer Telephony Integration: technology that integrates the communications functions of the telephone with data processing functions of the computer, making way for full interaction between the two types of devices.

DATABASE—Set of data linked by precise relations and grouped in a structured manner (records and fields). Databases are generally hosted on network servers and can be easily consulted through interrogations from PCs or DEVICES belonging to the same network or linked to the said network.

DEVICE—General term used to indicate the individual components of a system, even online. For instance: desktop computers, palmtop computers, intelligent terminals, printers, etc.

EMAIL—Electronic Mail

ETHERNET—The most widespread technology used by Local Area Networks (LANs).

FAX—System that allows for the transmission of pages (in the form of images) using a telephone line.

FILE—Data stored in digital form on a storage medium (hard drive, floppy disks, CDs, etc.). FIREWALL: Hardware and/or software device designed to deny access to computers connected to LANs by other computers connected to the same, or to other local networks or even the Internet, and in any event capable of reaching the former through computer and/or telephone connections, as well as of reading and/or acquiring the data and applications programmes stored on them.

HOME PAGE—First page of a website. The term also indicates the pre-set page displayed by browsers.

INTERNET PHONE (IP PHONE)—Communications device or terminal equipped with an interface and internal functions for forwarding and receiving telephone calls through the LAN, WAN or Internet network to which it is connected.

IP—Internet Protocol. The Level 3 protocol on which the Internet is based.

IP ADAPTER—Device capable of interfacing a common analogic telephone with a LAN data network, making it compatible with IP Phone.

IPPBX—Recently designed PABX telephone switchboards that apart from a circuit switching transport, provide data transmission functions that are compatible with the IP protocol.

KERNEL—The heart of the system or software programme for the management of hardware and software components.

LAN—Local area network. Computer networks that connects two or more computers and/or peripheral devices (for instance, printers, fax machines, scanners) within a rather limited area (local network) for the purpose of communicating and sharing files and data.

LOGGING—Recording of data pertaining to an event, such as, for instance, a telephone call, the receipt or sending of an e-mail, the date and time of a call, the caller's telephone number, etc.

MMS—Multimedia Messaging Service—Multimedia messaging service that allows for the creation of messages containing a combination of text, images, sound, melodies and film clips.

MOBILE NETWORK—Mobile telecommunications network

MoIP—Multimedia over IP, technology that manages Voice, Video, Fax, SMS, MMS, Data on the Internet.

MOUSE—Peripheral device that controls the movement of the cursor on the screen in keeping with the movement of the device itself, that is moved by the user's hand.

OPERATING SYSTEM—Set of programmes that regulates the use of the hardware and software resources of a processing system, making the said resources available to users.

PABX—Private Automatic Branch exchange—telephone switchboard that operates with circuit switching Technique, featuring certain automated functions.

PBX—Private Branch exchange—telephone switchboard that operates with circuit switching Technique enabling local communications and communications towards outside telecommunications networks

PDA—Personal Digital Assistant—A palmtop computer, an electronic diary or planner or any small digital device designed for personal use. The term has recently assumed a wider meaning to indicate all those mobile terminals devoid of telephonic functions.

PACKET SWITCHING—Technique used in communications networks in which information is transported from end to end through the storage and forwarding of elementary units of data known as packets that providing for efficient sharing of transmission resources.

PSTN—Public Switched Telephone Network. Telecommunications network with analogic access. The normal telephonic network for voice transmission.

ROUTER—Device for the interconnection and routing of data packets between computer networks.

SERVER—A set made up of an electronic processor and a software programme that offers services to clients (PCs or Devices in general) such as the storage of files (file server), programmes (applications server), the sharing of printers (print server), fax machines (fax server), modems (modem server), etc.

SYSTEMS ADMINISTRATOR: A person or group of persons placed in charge of managing the local LAN network and the servers as well as digital communications in general. A Systems Administrator may sometimes also be entrusted with assigning privileges and limits on the use that users can make of the said LAN.

SMS—Short Message Service—designed for sending or receiving messages of no more than 160 characters using cell phones that support this function.

SOFTPHONE—Application software that uses the processing capacity of a PC and a communications terminal, containing only the transmitter and acoustic receiver interconnected to it, so as to management telephone calls through LANs, WANs or the INTERNET.

SOFT SWITCH—Programme for an electronic processor capable of commuting and managing data pertaining to telecommunications.

TCP/IP—Transmission Control Protocol/Internet Protocol—acronym used to denote the family of Internet protocols and functions.

TV-SET—Complete TV monitor that could possibly be used for video conference calls.

UM—Unified Messaging, technology for the unified management of asynchronous communications (e-mail, voice mail, facsimile transmissions, etc.)

VoIP—Voice over IP. This term denotes the set of functions and architectures that allow for voice communications over networks with packet switching Technique, also ensuring interoperability with pre-existing telecommunications networks (PSTN, ISDN).

WAN—Wide Area Network. Computer network with a wider geographical extension that Local Area Networks. The largest WAN set up through the interconnection of various networks is the Internet.

WEB BROWSER—Computer programme that allows for the display of web pages. Browsers can read documents in html (hypertext markup language) format. The most widely used web browsers worldwide are Internet Explorer, Netscape and Opera.

WEBCAM—Small video recorder capable of being connected to a computer and of taking films or photos, saving them in a file or allowing for their transmission directly over the LAN, WAN or the Internet to which it is connected.

WIRELESS COMMUNICATION—This term denotes the process of data exchange without the use of wires or other cabled resources, through the transmission and reception of radio or optical signals. This technology is used even for wireless connections of Personal Computers, PDAs, mouse, keyboards, etc.

WORLD WIDE WEB (WWW) also known as the WEB—Set of hypertext servers accessible over the Internet to Clients using Web Browsers that provides access to a single global information system.

XDSL—X Digital Subscriber Loop—This abbreviation indicates various broadband transmission technologies on the last copper tract of the Telecommunications Network (ex.: ADSL, HDSL, VDSL, etc.)

### Legend to FIG. 1

1)—Local Area Network (LAN)
2)—Personal computer or Client processor—Device
3)—IP Phone—Communications terminal
4)—Palmtop computer or PDA that may include a loudspeaker and microphone—Device
5)—Personal Computer or Client processor fitted with headphones, a microphone and a webcam—Device
6)—Analog/digital and digital/analog Adaptor for analog phones (POTS).
7)—Analog telephone (POTS)—Communications terminal
8)—Standard analog fax machine—Communications terminal
9)—Router with or without a firewall
10)—Communications Device and/or Terminal for transmission/reception via satellite, connected to the LAN through a Router
11)—Internet
12)—Personal computer fitted with headphones, a microphone and a webcam, connected to the Internet—Device
13)—One or more additional LANs connected to the Internet, as well as to one or more Communications Devices and/or Terminals similar to those connected (2, 3, 4, 5, 6, 7, 8, 9, 10) to LAN (1), represented by the block (29) shown in this FIG.
14)—WEB SERVICES HTTP/XML (WS) logical/functional section dedicated to displaying and enabling the initiation, control and management of all types of communications, using an Internet Web Browser on the visual display panels of locally (2, 3, 4, 5, 7, 8, 10, 25) or remotely (28, 12) connected Communications Devices and/or Terminals, as well as over other networks (13)
15)—COMMUNICATIONS KERNEL (CK) logical-functional section dedicated to supporting all types of communications between Communications Devices and/or Terminals that are directly and indirectly connected to LAN (1), LAN (13), the Internet (11) as well as the fixed PSTN (26) and mobile (GSM, UMTS, etc. (24)) telecommunications networks. This section is also dedicated to checking and logging the historical data pertaining to the communications managed by the apparatus, in the database.
16)—PHONE COMMUNICATIONS CHANNEL (PCC) dedicated to interfacing, and if necessary, to carrying out conversions between the various online transmission protocols.

Examples of specific network connections include:
16a—connection of the Phone Communications Channel (PCC) to the LAN
16b—connection of the Phone Communications Channel to the Fixed Public Telecommunications Network (PSTN).
16c—connection of the Phone Communications Channel to the Mobile Public Telecommunications Network (GSM, UMTS, etc.)
17)—FAX COMMUNICATIONS CHANNEL (FCC) dedicated to interfacing, and if necessary, to carrying out conversions between the various online transmission protocols.

Examples of specific network connections include:
17d—connection of the Fax Channel to the LAN
17e—connection of the Fax Channel to the Public Telecommunications Network PSTN—ISDN
18)—SMS/MMS COMMUNICATIONS CHANNEL (SCC) dedicated to interfacing, and if necessary, to carrying out conversions between the various online transmission protocols.

Examples of specific network connections include:
18f—connection of the SMS/MMS Channel to the Mobile Public Telecommunications Network (GSM, UMTS, etc.)
18g—connection of the SMS/MMS Channel to the LAN
19)—VIDEO AND MULTIMEDIA COMMUNICATION CHANNEL (VCC) dedicated to interfacing, and if necessary, to carrying out conversions between the various online transmission protocols.

Examples of specific network connections include:
19h—connection of Video and Multimedia Channel to the Public Telecommunications Network (PSTN)
19i—connection of the Video and Multimedia Channel to the Public Mobile Network (GPRS, UMTS, Etc.)
19l—connection of the Video and Multimedia Channel to the LAN
20)—CHAT COMMUNICATIONS CHANNEL (CCC) dedicated to interfacing, and if necessary, to carrying out conversions between the various online transmission protocols.

Examples of specific network connections include:
20m—connection of the Chat Channel to the LAN
21)—E-MAIL COMMUNICATIONS CHANNEL (MCC) dedicated to interfacing, and if necessary, to carrying out conversions between the various online transmission protocols.

Examples of specific network connections include:
21n—connection of the E-mail Channel to the LAN
22)—OTHER COMMUNICATIONS CHANNELS (OCC) dedicated to interfacing, and if necessary, to carrying out conversions between the protocols of various communications systems and networks, other than those described such as IPv6, Multicast IP, etc.
23)—Single database
24)—Public Mobile Telecommunications Network (GSM, UMTS, etc.) including users equipped with mobile communications and video communications terminal.
25)—Telephonic Devices or Terminal/s for the Public Mobile Telecommunications Network (GSM, UMTS, etc.) with ISDN, GSM, GPRS and similar connections.
26)—Public Fixed Telecommunications Network (PSTN, ISON, etc.) including users equipped with fixed communications terminals
27)—Apparatus for all types of communications management made up of a Central Electronic Processor or Network Server and the related computer programmes as well as connection systems and direct interfacing with the fixed PSTN (26) and mobile (such as GSM, UMTS, etc. 24) telecommunications networks, satellite networks, LAN (1) and the Internet (11).
28)—Satellite Communications Device and/or Terminal for transmission and reception connected to the Device and/or Terminal by satellite (10).
29)—Group of Communications Devices and/or Terminals such as (2, 3, 4, 5, 6, 7, 8, 9, 10) individually connected to the related LAN (13) and identical to those connected to the LAN (1).

### Legend to FIGS. 2 and 3

30)—Internet Web Browser displayed on the visual display panels of Communications Devices and/or Terminals, containing, apart from the icons providing access to the Database (31), one (or more) toolbars containing data pertaining to the caller, the party called, the status of the communication (38) and icons for the real time management of one or more communications (32) that may also be simultaneous.
31)—Icon for access to the Database (23)
32)—Icon for real time communications management
30)—Graphic interface or page providing access to other sections of the Database (23)
31) 34)—Graphic interface or page providing access to other sections of the Database (23)
32)—Icon for enabling specific functions, especially functions providing access to the Database (23)
33)—Internet Web Browser displayed on the visual display panels of Communications Devices and/or Terminals, containing, apart from the icons providing access to the Database (31), several toolbars containing data pertaining to the caller, the party called, the status of communications (38) and icons for the real time management of several simultaneous communications (32). This example illustrates a call underway (Talk with) and two waiting calls (Suspended call).
34)—Internet Web Browser displayed on the visual display panels of Communications Devices and/or Terminals, containing, apart from the icons providing access to the Database (31), several toolbars each containing data pertaining to the caller, the party called, the status of communications (38) and icons for the real time management of several simultaneous communications (32). This example illustrates the caller's (Rossi Mario) visual display panel, two calls underway (Talk with and Calling) with the same party called (Bianchi Luigi) after the caller has enabled the Contemporaneous Multiple Call function by clicking on the CMC icon. The example also shows the different type of network used for each of the two calls underway (IP and PSTN).
35)—Data pertaining to the caller, the called party and other call-specific information
39)—Internet Web Browser displayed on the visual display panels of Communications Devices and/or Terminals, containing, apart from the icons providing access to the Database (31), several toolbars each containing data pertaining to the caller, the party called, the status of communications (38) and icons for the real time management of several simultaneous communications (32). In this example, the visual display panel of the called party (Bianchi Luigi) shows two calls underway (Talk with and Suspended call) originating from the same caller (Rossi Mario). The suspended PSTN call can be enabled by eliminating the IP call.

### Legend to FIG. 4

36)—IP Phone—Communications Terminal
37)—Personal Computer or Client processor—Device
41)—Personal computer od elaboratore Client—Device
42)—Analog/digital and digital/analog Adaptor for analog phones (POTS).
43)—Analog phone (POTS)—Communications Terminal
44)—Group of Communications Devices and Terminals as represented in FIG. 1, connected to the LAN (1) and simplified here in a single BLOCK
45)—Apparatus for all types of communications management, identical to the one described in FIG. 1 (27) made up of a Central Electronic Processor or Network Server and the related purpose-specific computer programmes as well as connection systems and direct interfacing with the fixed PSTN, ISDN, etc. (49) and mobile (such as GSM, UMTS, etc. 50) telecommunications networks, satellite networks, the LAN (48) and the Internet (51).
46)—Telephonic Devices or Terminal/s for the Public Mobile (GSM, UMTS, etc.) and/or Satellite Telecommunications Networks with ISDN, GSM, GPRS, etc. connections.
47)—Device containing the Router and Firewall connected to the Internet
48)—Local Area Network (LAN)
49)—Fixed Public Telecommunications Network (PSTN, ISDN, etc.)
50)—Mobile Public Telecommunications Network (GSM, UMTS, etc.)
51)—Internet
52)—Internet Service Provider with a database of number groups—THIRD PARTY
53)—IP Phone—Communications terminal
54)—Personal computer or Client processor—Device
55)—Apparatus for all types of communications management, identical to that described in FIG. 1 (27), made up of a Central Electronic Processor or Network Server and the related purpose-specific computer programmes as well as connection systems and direct interfacing with the fixed PSTN, ISDN, etc. (49) and mobile (such as GSM, UMTS, etc. 50) telecommunications networks, satellite networks, the LAN (61) and the Internet (51
56)—Telephonic Devices or Terminals for the Public Mobile (GSM, UMTS, etc.) and/or Satellite Telecommunications Networks with ISDN, GSM, GPRS, etc. connections
57)—Analog/digital and digital/analog Adaptor for analog phones (POTS).
58)—Analog phone (POTS)—Communications Terminal
59)—Device containing the Router and Firewall connected to the Internet
60)—Group of Communications Devices and Terminals as represented in FIG. 1, connected to the LAN (1) and simplified here in a single BLOCK
61)—Local Area Network (LAN)

1) Method for initiating, receiving, controlling and managing different types of synchronous and asynchronous communications over LAN, WAN and Internet networks, comprising the steps of:
providing Communications Devices and/or Terminals for permitting one or more users to transmit and receive synchronous and asynchronous communications;
providing Network Servers (27) and Local Area Network (LAN) infrastructures for transporting data and all the communications between the said Communications Devices and/or Terminals; wherein all the inbound and outbound communications are initiated, received, controlled and managed by using an Internet Web Browser, said operations being performed without using any a traditional telephone switchboard or exchange system of the PBX, PABX, and IPPBX type.

2) Method as claimed in claim 1, wherein all said inbound and outbound communications are initiated, received, controlled and managed employing only one central processor or Network Server (27) of a single Local Area Network LAN (1).

3) Method as claimed in claim 1, wherein said inbound and outbound communications include both synchronous and asynchronous communications.

4) Method as claimed in claim 1, wherein all said inbound and outbound communications, are initiated, received, controlled and managed either individually and/or by mixing two or more simultaneous communications.

5) Method as claimed in claim 1, wherein said inbound and outbound communications are initiated, received, controlled and managed, even mixing different types of all said communications.

6) Method as claimed in claim 1, wherein said inbound and outbound communications include the communications from Communications Devices (2, 3, 4, 5, 7, 8, 10) and/or stand alone Terminal devices situated in remote locations (12), or devices associated (29) with other remote LANs (13), said Communications Devices or Terminals (12, 29) being connected, through digital networks, including the Internet (11), to the Local Area Network LAN (1) to which said central electronic processor or Network Server (27) is associated, said remote Communications Devices and/or Terminals (12, 29) interacting through said central processor or Network Server (27), both amongst themselves and with the Communications Devices and/or Terminals (2,3,4, 5, 7, 8, 10) connected to said Local Area Network LAN (1).

7) Method as claimed in claim 1, wherein said inbound and outbound communications are effected, through direct and/or indirect connections, between said central processor or Network Server (27) and the communications terminals of public and private communications networks for wired telecommunications and video communications (26) as well as the communications networks for wireless telecommunications or video communications (24) and satellite networks.

8) Method as claimed in claim 1 claim 1, wherein said inbound and outbound communications are effected between the Communications Devices and Terminals (2, 3, 4, 5, 7, 8, 10, 12, 29, 28), connected to said LAN (1) or to remote LANs (13) and/or the Internet (11) or satellite networks, and the communications terminals of the users of said public and private communications networks for wired telecommunications and video communications (26) as well as the communications networks for wireless telecommunications or video communications (24).

9) Method as claimed in claim 1, wherein each communication channel (16, 17, 18, 19, 20, 21, 22) of all said inbound and outbound communications is activated, controlled and managed by using a single software programme equipped with a single central software nucleus (15) (KERNEL) installed on said single central processor or Network Server (27), and by using Browser interactive graphic interfaces (30) enabled by a section (14) (Web Services) of said central processor or network server (27) and displayed on the visual display panels of the Communications Devices or Terminals (2, 3, 4, 5, 7, 8, 10, 12, 29, 28) connected to said Local Computer Networks LANs (1, 13), satellite networks, the Internet (11) or other networks.

10) Method as claimed in claim 1, wherein operating functions for the management of different types of communications and display of data pertaining to a caller and a party called, as well as other data pertaining to the said ongoing communications (38), are activated through access to specific sections of a Database (23) by using an Internet Web Browser, said Web Browser comprising at least one graphic toolbar (30) featuring two distinct groups of interactive icons (31,32).

11) Method as claimed in claim 1, wherein all said inbound and outbound communications are activated, controlled and managed by using an Internet Web Browser and employing Personal Computers and/or standard telephones, without using any specific communications equipment custom-designed to support said functions of activating, receiving, controlling and managing different types of communications.

12) Method as claimed in claim 1, wherein all said inbound and outbound communications are effected among Communications Devices, Terminals, and Personal Computers connected to LANs (1, 13), to the Internet (11), to satellite networks, or to other networks, regardless of the type of operating system used to drive said Devices, Terminals and Personal Computers.

13) Method as claimed in claim 1, further comprising the step comprising:
logging and storing in a single database (23) all data pertaining to all communications effected through any Communications Device and/or Terminal (2, 3, 4, 5, 7, 8, 10, 12, 29, 28) connected to and/or interacting with said LAN (1) or group of LANs (1, 13), or satellite network, or other networks.

14) Method as claimed in claim 1, comprising the step of routing each call only after the system has automatically searched for and selected the cheapest communications network available for each type of communication placed from Communications Devices and/or Terminals (2, 3, 4, 5, 7, 8, 10, 12, 29, 28) connected to LANs (1, 13) to Communications Devices and/or Terminals connected to the same LANs or to other public or private wired (26) or wireless (24) telecommunications or video communications networks, or satellite or other types of networks.

15) Method as claimed in claim 1, comprising the step of searching and selecting 50 automatically the cheapest communications network (49, 50, 51) when the calls placed from Communications Devices or Terminals (40, 41,43, 44, 53, 54, 58, 60) connected to LANs (48, 61) that are part of the in-house communications infrastructure of a same corporate group or company, are addressed to the party called using this same method and belonging to a specific wired or wireless telephony or videophony number grouping.

16) Method as claimed in claim 1, comprising the step of searching and selecting automatically the cheapest communication network (49, 50, 51) when the calls placed from the Communications Devices or Terminals (40, 41, 43, 44) connected to the LAN (48), and addressed to the Communication Devices or Terminals (53,54, 58,60), connected to a LAN (61) that does not belong to the communications infrastructure of a same group or corporation, in the case where the parties called use the same method and belong to a specific wired or wireless telephony or videophone number grouping, are managed and addressed to the party called, by an Internet Service Provider or Third Party (52) entrusted with the task of discriminating access, and as a result, of enabling connections only between authorised numbers, so as to ensure secure access to the LAN and to the called Communications Devices and/or Terminals (53, 54, 58,60), belonging to said specific number grouping, through authentication upon the initiation of the call.

17) Method as claimed in claim 1 wherein all said types of communications to and from the communications terminals connected to public and private communications networks for wired (26) and wireless (24) telecommunications and video communications, satellite or other networks, are initiated, received, controlled and managed, through the use of an Internet Web Browser installed on the Communications Devices and Terminals that may be either stand alone (12) or connected (29) to LANs (13) situated in remote locations and in any event connected through digital networks or the Internet, to the Local Area Network LAN (1) that incorporates said central processor or Network Server (27)-

18) Method as claimed in claim 1, wherein all said types of communications are initiated, received, controlled and managed, even between Communications Devices and/or Terminals situated in remote locations either stand-alone (12) or connected (29) to LANs (13) situated in remote locations, themselves connected to the LAN (1) that incorporates said central processor or Network Server (27), through digital networks or the Internet.

19) Method as claimed in claim 1, wherein, an Internet Web Browser incorporating one or more Toolbars (30) is used to initiate, receive, control and manage all said types of communications from any Communications Device or Terminal (40,41,43,44) connected to the LAN (48) and equipped or associated with a visual display panel, with one or more simultaneous outbound calls (37) being sent automatically or manually by the caller (40, 41,43, 44) over various telecommunications and/or video communications networks (49, 50, 51) so as to reach the party called (53, 54, 58, 60) connected to another LAN (61), such called party being able to use the method and the Internet Web Browser incorporating one or more Toolbars (30) to initiate, receive, monitor and manage one or more simultaneous telecommunication and/or video communication calls (39).

20) Apparatus for initiating, receiving, controlling and managing different types of synchronous and asynchronous communications over LAN, WAN and Internet networks among Communications Devices and/or Terminals permitting one or more users to transmit and receive and asynchronous communications) and multimedia synchronous and asynchronous communications, said apparatus comprising a single central processor or Network Server (27) and a single type of Local Area Network LAN (1) infrastructure for transporting data and all the communications on the same LAN (I), without the need for a telephone switchboard or exchange system of the PBX, PABX, IPPBX type.

21) Apparatus as claimed in claim 20, wherein said central processor or Network Server (27) includes means for interacting, through direct and/or indirect connections, with public and private communications networks for wired (26) and wireless (24) telecommunications and video communications, and satellite networks, such central processor or Network Server (27) accordingly being capable of connecting with the communications terminals of the users of said networks (26, 24, etc.) as well as of connecting the latter with the Communications Devices and Terminals (2, 3, 4, 5, 7, 8, 10, 12, 29, 28) connected to LANs (1, 13), satellite networks or the Internet (11).

22) Apparatus as claimed in claim 20, wherein said central processor or Network Server (27) features a single installed software programme equipped with a kernel (15) that enables the initiation, reception, control and management of each communications channel (16, 17, 18, 19, 20, 21, 22) of all said types of communications through the display of an Internet Web Browser incorporating a toolbar (30) that interacts 25 with the Web Services section (14) of the apparatus.

23) Apparatus as claimed in claim 20, comprising a means for using an Internet Web Browser to display and/or make available the initiation, reception, control and management of said overall communications on Communications Devices and/or Terminals (2, 3, 4, 5, 7, 8, 10, 12, 29, 28) used by users, without using any specific communications equipment custom-designed to support the aforesaid functions of initiating, receiving, controlling and managing said overall communications.

24) Apparatus as claimed in claim 20, a Personal Computer Devices connected to Local Area Networks LANs (1, 13), to the Internet, to satellite networks, or to other networks, regardless of the operating system used to drive said Devices, Terminals and Personal Computers.

25) Apparatus as claimed in claim 20, comprising a single database (23) in which all the data pertaining to all the communications effected through any Communications Device and/or Terminal (2, 3, 4, 5, 7, 8, 10, 12, 29, 28) connected to and/or interacting with said LAN (1) or group of LANs (1, 13), are logged and stored.

26) Apparatus as claimed in claim 20, wherein said central processor includes:
logical-functional sections designed to support and manage all said types of communications; and
at least one section for the storage, in a single centralised Database, of the settings associated with said devices as well as of the log of the historical data pertaining to the said communications.

27) Apparatus as claimed in claim 26, wherein said logical-functional sections are dedicated:
to interfacing (16-22) said apparatus with the Communications Devices and/or Terminals connected to said local area network LAN (I), to wired and wireless telecommunications networks as well as to other computer networks, including the Internet;
to managing (15) said communications between the Communications Devices and/or Terminals connected to said local area network LAN (1) and between said Communications Devices and/or Terminals and the telecommunications networks and other computer networks;
to logging (23) the historical data pertaining to the communications managed by said apparatus;
to displaying (14) on the visual display panels of the Communications Devices and/or Terminals connected to the computer networks, the interactive graphic interfaces and to managing such interfaces so as to allow, using standard browser methodology, access to and the activation of the operating functions of said apparatus.

28) Apparatus as claimed in claim 27, wherein said managing section (15) supports communications amongst the various Communication devices and/or Terminals (2, 3,4, 5, 7, 8, 10, 12, 29, 28) by retrieving from the storage section (23) the settings associated with each said Communications Device and/or Terminal (2,3,4,5,7, 8, 10, 12,29,28).

29) Apparatus as claimed in claim 20, wherein said Communications Devices and/or Terminals connected to the local area network LAN (1) include the following:
a Personal Computer or Client Processor,
an IP Phone,
a Palmtop PDA Computer that may be fitted with a loudspeaker and microphone,
a Personal Computer or Client Processor fitted with headphones, a microphone and a webcam,
a POTS analogue phone,
a standard analogue fax machine,
a Router with or without a firewall (9),
a Communications Device and/or Terminal (10) enabling transmission and reception via satellite, connected to the LAN through the Router (9),
a Personal Computer or Client Processor, connected to the Internet, and fitted with headphones, a microphone and a webcam,
a telephone Device or Terminal (25) for the public wireless telecommunications network and
a Communications Device and/or Terminal (10) enabling transmission and reception via satellite, connected by satellite to the Communications Device and/or Terminal.

30) Apparatus as claimed in claim 26, wherein said logical-functional sections (16-22) designed to interface said apparatus with equipment connected to the local computer network, wireless telephone devices, wired telephone devices and the Internet, include:
a section (16) that, in respect of telephone calls, acts as an interface between said apparatus and said local area network LAN (16a), a public PSTN telecommunications network (16b) and a public GSM/UMTS wireless network (16c);
a section (17) that, in respect of facsimile transmissions, acts as an interface between said apparatus and said local area network LAN (17d) as well as the public PSTN telecommunications network (17e);
a section (18) that, in respect of wireless telephone messages, acts as an interface between said apparatus and wireless telephone devices (18g) and the local area network LAN (18g);
a section (19) that, in respect of video and multimedia communications, acts as an interface between said apparatus and the local area network LAN (19l), the public PSTN telecommunications network (19h) and the public GSM/UMTS wireless network (19i);
a section (20) that, in respect of real time computer communications, acts as an interface between said apparatus and the local area network LAN (20m);
a section (21) that, in respect of e-mail communications, acts as an interface between said apparatus and the local area network LAN (21n);
a section (22) that acts as an interface between said apparatus and said local area 20 network LAN, in respect of any and all types of communications other than those mentioned above.

31) Apparatus as claimed in claim 25, wherein the access to specific sections of said Database (23) and the activation of the operating functions of said apparatus as well as the display of the data pertaining to the called party and the caller, and other data pertaining to the call underway, are enabled through interacting with two distinct groups of icons (31, 32) that appear on the Internet Web Browser displaying a graphical toolbar (39).

32) Apparatus as claimed in claim 20, comprising means for routing each call only after the system has automatically searched for and selected the cheapest communications network available for each type of communication placed from Communications Devices and/or Terminals (2, 3,4, 5, 7, 8, 10, 12, 29, 28) connected to LANs (1, 13) to Communications Devices and/or Terminals connected to the same LANs or to other public or private wired (26) or wireless (24) telecommunications or video communications networks, or 35 satellite or other types of networks.

33) Apparatus as claimed in claim 20, comprising means for automatically searching and selecting the cheapest communications network (49, 50,51) when the calls placed from Communications Devices or Terminals (40,41,43,44, 53, 54, 58, 60) connected to LANs (48, 61) that are part of the in-house communications infrastructure of the same corporate group or company, are addressed to a party called that uses this same method and belongs to a specific wired or wireless telephony or videophone number grouping.

34) Apparatus as claimed in claim 32, comprising means for automatically searching and selecting the cheapest communication network (49, 50, 51) when the calls placed from the Communications Devices or Terminals (40, 41, 43, 44) connected to the LAN (48) and addressed to Communication Devices or Terminals (53,54, 58,60), connected to a LAN (61) that does not belong to the communications infrastructure of the same group or corporation, in the case where the parties called use the same method and belong to a specific wired or wireless telephone or videophone number grouping, are managed and addressed to the party called by an Internet Service Provider or Third Party (52) entrusted with the task of discriminating access, and as a result, of enabling connections only between authorised numbers, so as to ensure secure access to the LAN and to the called Communications Devices and/or Terminals (53, 54, 58, 60), belonging to the said specific number grouping, through authentication upon the initiation of the call.

35) Apparatus as claimed in claim 20, comprising means for using an Internet Web Browser to enable, receive, control and manage all said types of communications to and from communications terminals connected to public and private communications networks for wired (26) and wireless (24) telecommunications and video communications, satellite or other networks, even through Communications Devices and Terminals that may be either stand alone (12) or connected (29) to LANs (13) situated in remote locations and in any event, connected through digital networks or the Internet to said Local Area Network LAN (1) that includes said central processor or Network Server (27).

36) Apparatus as claimed in claim 20, comprising means for initiating, receiving, controlling and managing all said types of communications even between Communications Devices and/or Terminals situated in remote locations, that may be either stand-alone (12) or connected (29) to LANs (13) situated in remote locations, themselves connected to said LAN (1) that includes said central processor or Network Server (27), through digital networks or the Internet.

37) Apparatus as claimed in claim 20, comprising means for using an Internet Web Browser incorporating one or more Toolbars (30), to enable, receive, monitor and manage communications from any Communications Device or Terminal (40, 41,43, 44) connected to the LAN (48), equipped or associated with a visual display panel, with one or more simultaneous outbound calls (37) being sent automatically or manually by the caller (40, 41, 43, 44) over various telecommunications and/or video communications networks (49, 50, 51) so as to reach the party called (53, 54, 58, 60) connected to another LAN (61), such called party being able to use the above method and said Internet Web Browser including one or more Toolbars (30), to enable, receive, monitor and manage one or more simultaneous telecommunications and/or video communications calls (39).

38) Apparatus as claimed in claim 20, wherein the operating functions accessed and activated from any Communications Device and/or Terminal using Internet Web Browser methodology include:
in the case of telephone or video calls: the recording of the call, placing the caller on hold, redirecting the call to another terminal, the initiation of a conference call with several users, attribution to a cost centre, direct connection to a web-based database, enabling and managing multiple outbound and inbound calls simultaneously, automatic dialling of a number stored in the phone book, notice of calls received; and
in the case of facsimile transmission, SMS, MMS and e-mail messages: simultaneous and sequential sending to several users, attribution of the communication to a cost centre, notice of arrival of the message or facsimile transmission using a flashing icon, as well as the logging of the data pertaining to the communication.
